(19) United States
(12) Patent Application Publication
(10) Pub. No.: US 2021/0107332 A1
(43) Pub. Date: Apr. 15, 2021

(54) DEMISTER AIR DUCT ASSEMBLY

(71) Applicant: Ford Global Technologies, LLC, Dearborn, MI (US)

(72) Inventors: Gary D. Mullen, Plymouth, MI (US); Mitali Chakrabarti, Canton, MI (US); John A. Shinska, Dearborn, MI (US); Daniel D. Mitchell, Southgate, MI (US); Martin Alfred Lindell, III, Oak Park, MI (US)

(73) Assignee: Ford Global Technologies, LLC, Dearborn, MI (US)

(21) Appl. No.: 16/601,656

(22) Filed: Oct. 15, 2019

(51) Int. Cl. B60H 1/00

(52) U.S. Cl. CPC B60H 1/00564

(57) ABSTRACT

An air duct includes an inlet and an outlet that are interconnected with one another by a curved intermediate portion. A plurality of chambers are disposed within the curved intermediate portion. Each chamber of the plurality of chambers includes a first end opening into the inlet and a second end opening into the outlet. An enclosed body portion interconnects the first and second ends of each chamber. The curved intermediate portion further includes a first cross-sectional configuration disposed at a first portion of the curved intermediate portion, and a second cross-sectional configuration that is different from the first cross-sectional configuration disposed at a second portion of the curved intermediate portion. The second portion of the curved intermediate is disposed downstream from the first portion of the curved intermediate portion. The air duct directs airflow in a demisting sequence and is further contemplated to be formed using an additive manufacturing process.

### FIELD OF THE INVENTION

The present invention generally relates to a demister air duct, and more particularly, to an air duct configured to direct airflow from a vehicle pillar to a side window surface using a plurality of integrated chambers.

### BACKGROUND OF THE INVENTION

Side window demist ducting and venting often includes an arduous route for channeling airflow to a side window surface in the form of multiple angles which cause air to lose momentum and associated clearing power. Multiple pieces are often needed to create such a convoluted path to demist a side window. A single piece duct system with integrated channels directing airflow is desired.

### SUMMARY OF THE INVENTION

According to one aspect of the present invention, an air duct includes a supply channel, an outlet, and an intermediate portion interconnecting the supply channel and the outlet. A plurality of chambers is disposed within an interior portion of the intermediate portion. Each chamber of the plurality of chambers includes a first end opening into the supply channel, a second end opening into the outlet and an enclosed body portion interconnecting the first and second ends.

According to another aspect of the present invention, an air duct includes a supply channel, an outlet and an intermediate portion interconnecting the supply channel and the outlet. The intermediate portion includes opposed first and second sidewalls spaced-apart from one another to at least partially define an interior portion of the intermediate portion. A partition is disposed within the interior portion of the intermediate portion and interconnects the opposed first and second walls to define first and second interior channels. The first and second interior channels each include a first end opening into the supply channel and a second end opening into the outlet.

According to yet another aspect of the present invention, an air duct includes an inlet and an outlet interconnected to the inlet by a curved intermediate portion. A plurality of chambers is disposed within the curved intermediate portion. Each chamber of the plurality of chambers includes a first end opening into the inlet, a second end opening into the outlet and an enclosed body portion interconnecting the first and second ends. The curved intermediate portion includes a first cross-sectional configuration disposed at a first portion of the curved intermediate portion, and a second cross-sectional configuration that is different from the first cross-sectional configuration disposed at a second portion of the curved intermediate portion. The second portion of the curved intermediate portion is disposed downstream from the first portion of the curved intermediate portion.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of a vehicle interior showing an air duct in phantom and disposed within an A-pillar and further illustrating airflow from the air duct to an inner surface of a glass pane;

FIG. 2 is a top perspective view of an air duct;

FIG. 3 is a bottom perspective view of the air duct of FIG. 2;

FIG. 4 is a bottom plan view of the air duct of FIG. 2;

FIG. 5 is a side elevation view of the air duct of FIG. 2;

FIG. 6 is a cross-sectional view of the air duct of FIG. 5 taken at line VI;

FIG. 7 is a cross-sectional view of the air duct of FIG. 5 taken at line VII;

FIG. 8 is a side elevation view of the air duct of FIG. 2 with various cross-sectional configurations shown in phantom; and

FIG. 9 is a cross-sectional view of the air duct of FIG. 8 taken at line IX.

### DETAILED DESCRIPTION OF THE PREFERRED EMBODIMENTS

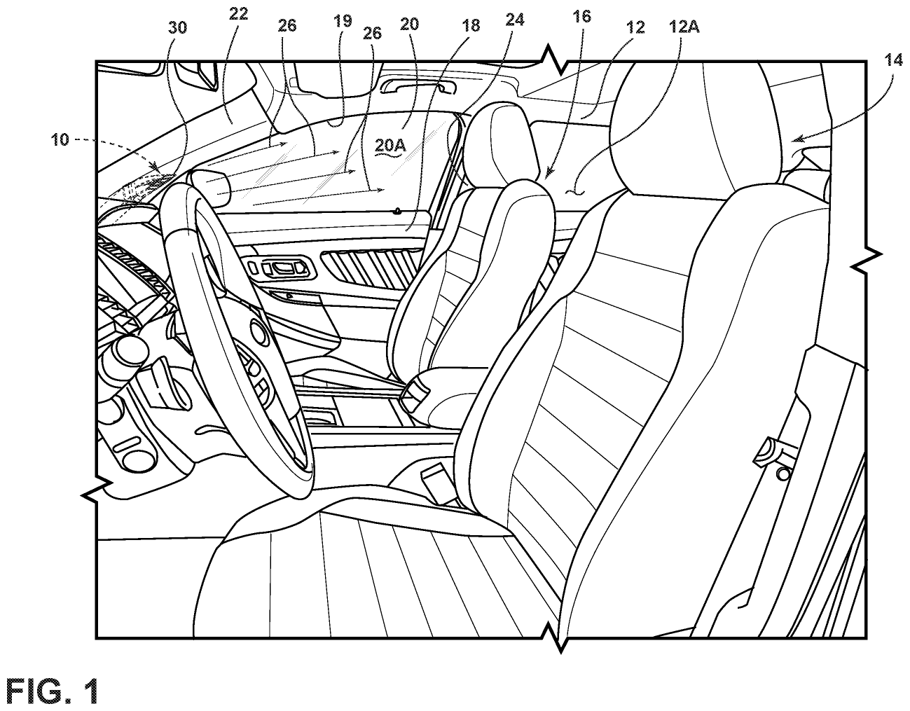

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring now to FIG. 1, a vehicle 12 is shown having a vehicle interior 12A with a driver's side seat assembly 14 and a passenger's side seat assembly 16. A passenger door 18 is shown having a window 19 with a glass pane 20 disposed therein and configured for vertical adjustment within the window 19. The glass pane 20 includes an inner surface 20A. The passenger door 18 is disposed between a first pillar 22 and a second pillar 24, which may be referred to herein as A-pillar 22 and B-pillar 24. Within the A-pillar 22, an air duct 10 is disposed and shown in phantom. The air duct 10 includes an outlet 30 that is directed towards the inner surface 20A of the glass pane 20. In use, the air duct 10 directs airflow from the outlet 30 of the air duct 10 to the inner surface 20A of the glass pane 20, as indicated by arrows 26, to demist and clear the inner surface 20A of the glass pane 20. While the air duct 10 is shown in FIG. 1 as being disposed in the A-pillar 22 on a passenger's side of the vehicle 12, it is contemplated that the air duct 10 may be positioned in any pillar within the vehicle 12 for demisting any associated glass pane.

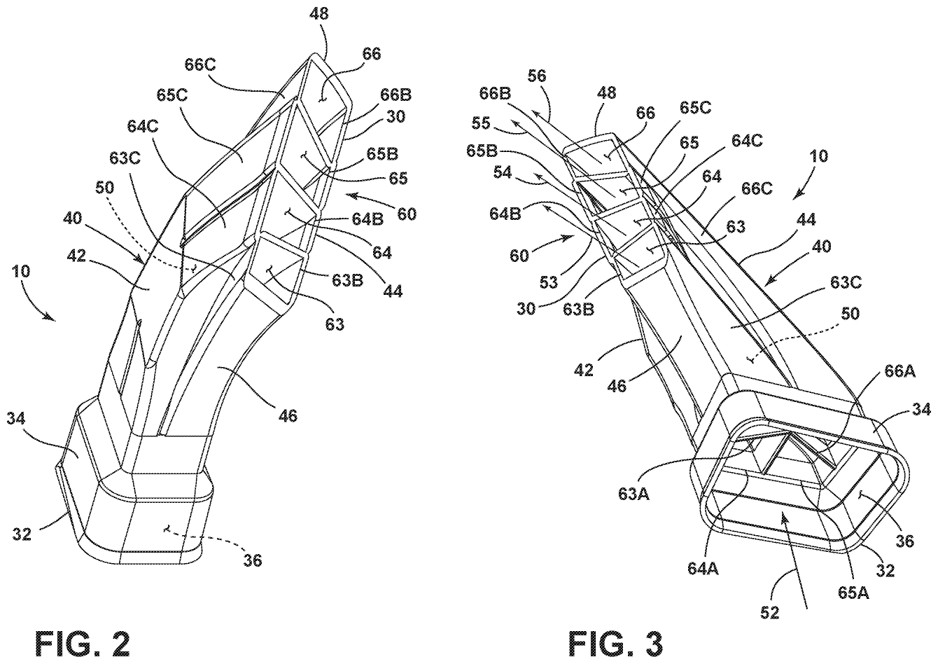

Referring now to FIGS. 2 and 3, the air duct 10 includes an inlet 32 opening into a coupling portion 34. The coupling portion 34 is configured to couple the air duct 10 to a vehicle heating, ventilation, and air conditioning system (HVAC system). The coupling portion 34 defines a supply channel 36 (FIG. 3) that is an open and unobstructed channel for receiving air supplied by the vehicle HVAC system. Thus, the inlet 32 defines an outer edge of the coupling portion 34 and supply channel at which air from the vehicle HVAC system is introduced into the air duct 10.

With further reference to FIGS. 2 and 3, an intermediate portion 40 of the air duct 10 is shown interconnecting the supply channel 36 and the outlet 30. The intermediate portion 40 is a curved portion of the air duct 10 that is configured to direct air through the air duct 10 in an efficient manner, such that a resulting plume of air (shown as arrows 26 in FIG. 1) exiting the outlet 30 of the air duct 10 is effectively directed at a target, such as the inner surface 20A of the glass pane 20 (FIG. 1). The intermediate portion 40 includes a first wall 42 that is spaced-apart from a second wall 44. The first wall 42 and the second wall 44 are interconnected by opposed first and second sidewalls 46, 48. Together, the first wall 42, the second wall 44 and the first and second sidewalls 46, 48 cooperate to define an interior portion 50 of the intermediate portion 40. Thus, the first wall 42 and the second wall 44 are opposed walls that partially define the interior portion 50 of the intermediate portion 40. As shown in FIG. 3, an intake airflow enters the supply channel 36 from an associated vehicle HVAC system in a first direction as indicated by arrow 52. The airflow is redirected within the curved intermediate portion 50 of the air duct 10, such that the airflow exits the outlet 30 at multiple directions, indicated by arrows 53, 54, 55 and 56.

As further shown in FIGS. 2 and 3, a plurality of chambers 60 is disposed within the interior portion 50 of the intermediate portion 40. The plurality of chambers 60 includes individual chambers 63, 64, 65 and 66. Each chamber 63, 64, 65, 66 of the plurality of chambers 60 includes a first end 63A, 64A, 65A, 66A opening into the supply channel 36, and a second end 63B, 64B, 65B, 66B opening into the outlet 30. Each chamber 63, 64, 65, 66 of the plurality of chambers 60 further includes an enclosed body portion 63C, 64C, 65C, 66C interconnecting the first ends 63A, 64A, 65A, 66A with the second ends 63B, 64B, 65B, 66B. Each chamber 63, 64, 65 and 66 may be individually referred to herein as first chamber 63, second chamber 64, third chamber 65 and fourth chamber 66. While four chambers 63, 64, 65 and 66 are included in the plurality of chambers 60 in the embodiment of FIGS. 1 and 2, it is contemplated that more or less chambers may be provided within the interior portion 50 of the intermediate portion 40 to effectively deliver airflow in a demisting sequence.

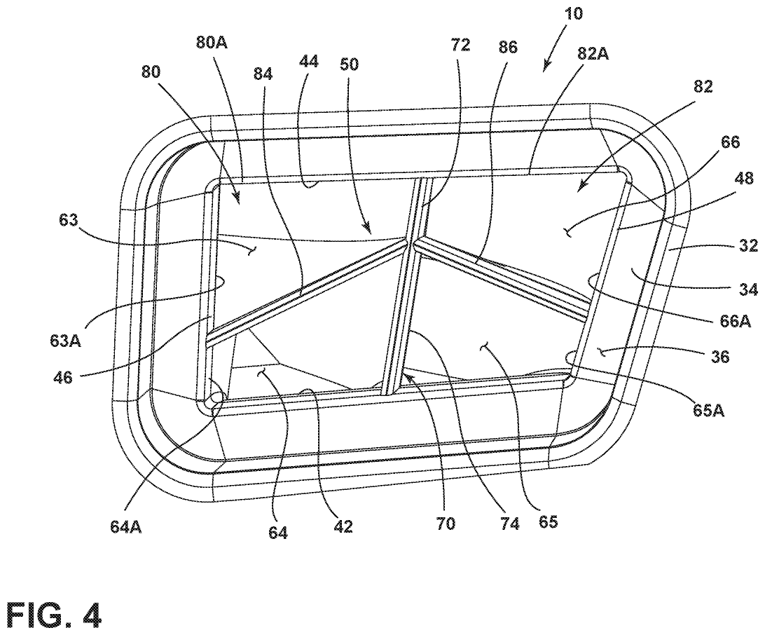

Referring now to FIG. 4, a partition 70 is disposed within the interior portion 50 of the intermediate portion 40. The partition 70 interconnects the opposed first and second walls 42, 44 to separate the interior portion 50 and define first and second interior channels 80, 82. The first interior channel 80 includes a first end 80A that is defined by first ends 63A, 64A of first and second chambers 63, 64. As such, the first end 80A of the first interior channel 80 opens into the supply channel 36. Similarly, the second interior channel 82 includes a first end 82A that is defined by first ends 65A, 66A of third and fourth chambers 65, 66. As such, the first end 82A of the second interior channel 82 opens into the supply channel 36. Thus, the first interior channel 80 is comprised of and defined by the first and second chambers 63, 64, and the second interior channel 82 is comprised of and defined by the third and fourth chambers 65, 66. A first divider 84 interconnects the partition 70 with the first sidewall 46. A second divider 86 interconnects the partition 70 with the second sidewall 48. Together, the first and second dividers 84, 86 separate the partition 70 into first and second portions 72, 74. As shown in FIG. 4, the first and second chambers 63, 64 are separated by the first divider 84 and disposed in a stacked configuration with the first chamber 63 disposed over the second chamber 64 within the first interior channel 80. Thus, the first divider 84 divides the first interior channel 80 into the first and second chambers 63, 64. As further shown in FIG. 4, the third and fourth chambers 65, 66 are separated by the second divider 86 and disposed in a stacked configuration with the third chamber 65 disposed over the fourth chamber 66 within the second interior channel 82. The first portion 72 of the partition 70 separates the first chamber 63 and the fourth chamber 66 which are aligned with one another in FIG. 4. The second portion 74 of the partition 70 separates the second chamber 64 and the third chamber 65 which are aligned with one another in FIG. 4. Thus, the second divider 86 divides the second interior channel 82 into the third and fourth chambers 65, 66.

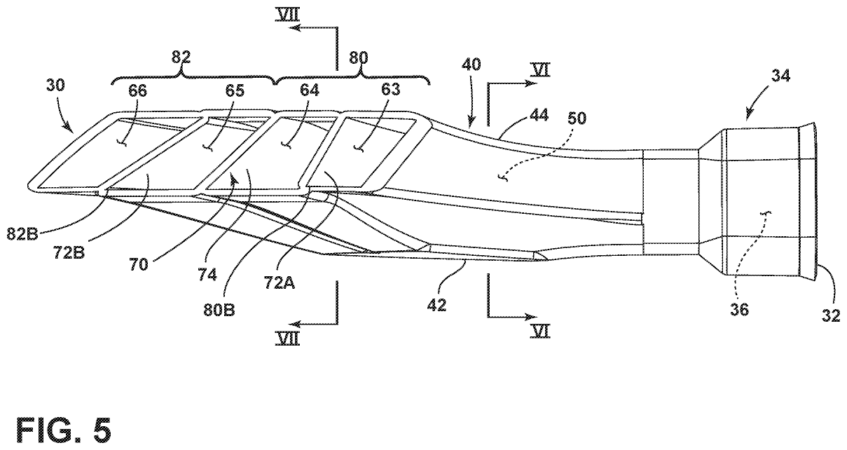

Referring now to FIG. 5, the first interior channel 80 further includes a second end 80B that is defined by second ends 63B, 64B of first and second chambers 63, 64. As such, the second end 80B of the first interior channel 80 opens into the outlet 30. Similarly, the second interior channel 82 includes a second end 82B that is defined by second ends 65B, 66B of third and fourth chambers 65, 66. As such, the second end 82B of the second interior channel 82 opens into the outlet 30. While the first chamber 63 and the fourth chamber 66 were aligned with one another in FIG. 4, they are now spaced-apart from one another in FIG. 5. The second chamber 64 and the third chamber 65 were aligned with one another in FIG. 4, and remain aligned with one another in FIG. 5. Thus, at the second ends 63B, 64B, 65B, 66B of the chambers 63, 64, 65, 66, all of the chambers are positioned in next to one another in a common row. As noted above, the chambers 63, 64, 65, 66 are in a stacked configuration in FIG. 4. Thus, the chambers 63, 64, 65, 66 may curve, twist and separate from one another to provide for evenly distributed airflow from the supply channel 36 to the outlet 30 in an uninterrupted, smooth and continuous manner. It is contemplated that the configuration of the interior portion 50 of the intermediate portion 40 of the air duct 10 is created using an additive manufacturing technique, such as a 3D printing method, to provide the necessary contours found in the plurality of chambers 60.

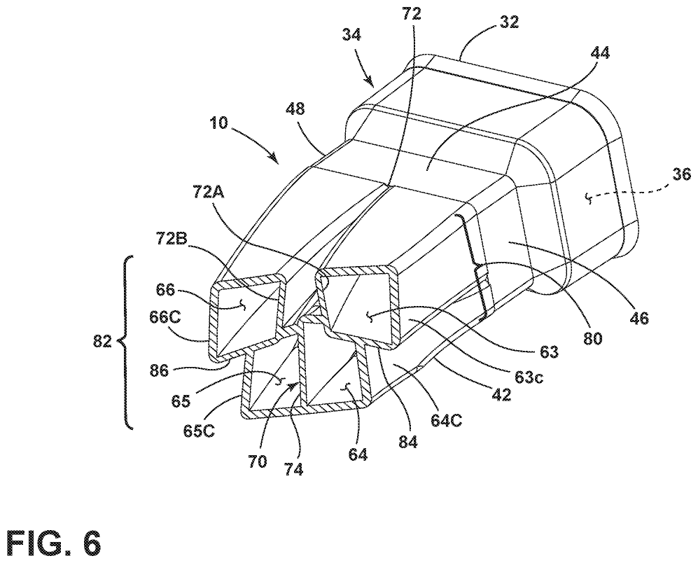

With further reference to FIG. 4, the first chamber 63 and the fourth chamber 66 are separated by the first portion 72 of the partition 70 in a side-by-side configuration. Similarly, the second chamber 64 and the third chamber 65 are separated by the second portion 74 of the partition 70 in a side-by-side configuration. With further reference to FIG. 5, the first and second chambers 63, 64 are provided in a side-by-side configuration as separated by a first wall 72A of the first portion 72 of the partition 70 at the outlet 30. The third and fourth chambers 65, 66 are provided in a side-by-side configuration as separated by a second wall 72B of the first portion 72 of the partition 70 at the outlet 30. Thus, the first portion 72 of the partition 70 splits from the first ends 63A, 64A, 65A, 66A of the chambers 63, 64, 65 and 66, to the second ends 63B, 64B, 65B, 66B of the chambers 63, 64, 65 and 66. The splitting configuration of the first portion 72 of the partition 70 is best shown in FIG. 6.

Referring now to FIG. 6, the first chamber 63 and the fourth chamber 66 are shown as separating from one another, such that the first portion 72 of the partition 70 splits into the first wall 72A and the second wall 72B. As the first chamber 63 and the fourth chamber 66 separate from one another, the first chamber 63 and the fourth chamber 66 move towards the outer edges of the intermediate portion 40.

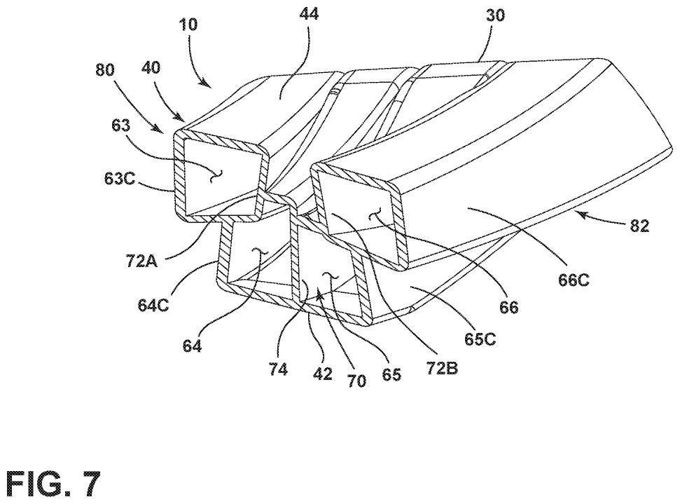

Referring now to FIG. 7, the first chamber 63 and the fourth chamber 66 are shown as being further separated from one another as each chamber 63, 66 approaches the outlet 30. The second chamber 64 and the third chamber 65 are shown as having an upwardly curved cant from the cross-sectional plane of FIG. 7 towards the outlet 30.

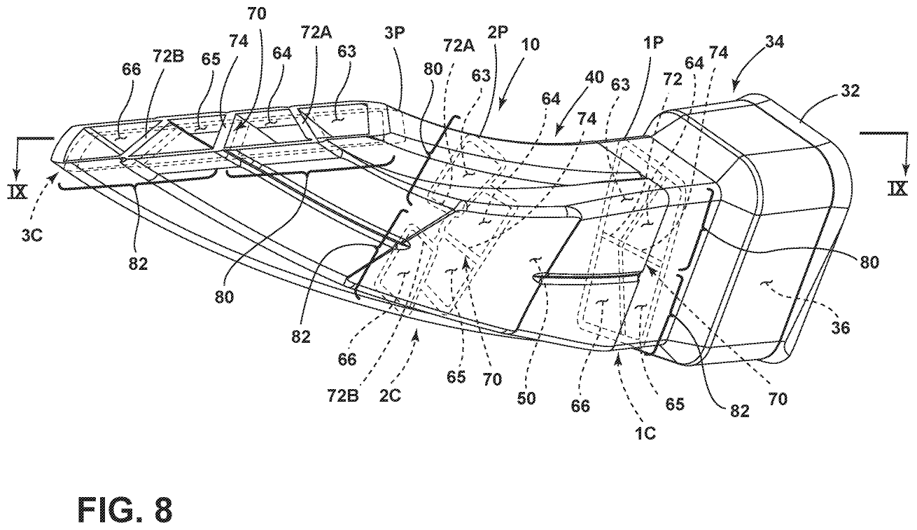

Referring now to FIG. 8, a first cross-section 1C is shown in phantom at a first portion 1P of the intermediate portion 40 disposed adjacent the supply channel 36. Further, a second cross-section 2C is shown in phantom at a second portion 2P of the intermediate portion 40. Finally, a third cross-section 3C is shown in phantom at a third portion 3P of the intermediate portion 40. As noted above, the supply channel 36 supplies air to the air duct 10 from a vehicle HVAC system. Thus, airflow through the air duct 10 moves downstream from the inlet 32 to the outlet 30 through the intermediate portion 40. In FIG. 8, the first portion 1P of the intermediate portion 40 is disposed just downstream from the inlet 32, and includes the first chamber 63 and the second chamber 64 shown in a stacked configuration as separated by the first divider 84. The first chamber 63 and the fourth chamber 66 are shown in a side-by-side configuration as separated by the first portion 72 of the partition 70 at the first portion 1P of the intermediate portion 40. Similarly, the fourth chamber 66 and the third chamber 65 are shown in a stacked configuration as separated by the second divider 86 at the first portion 1P of the intermediate portion 40. The third chamber 65 and the second chamber 64 are shown in a side-by-side configuration as separated by the second portion 74 of the partition 70 at the first portion 1P of the intermediate portion 40. In FIG. 8, the second portion 2P of the intermediate portion 40 is disposed downstream from the first portion 1P, and includes the second cross-section 2C, wherein the third chamber 65 and the second chamber 64 are still shown in a side-by-side configuration as separated by the second portion 74 of the partition 70. At the second portion 2P of the intermediate portion 40, the first chamber 63 and the fourth chamber 66 are shown as separating from one another, and are no longer adjacent to one another like they are at the first portion 1P of the intermediate portion 40.

As further shown in FIG. 8, the third portion 3P of the intermediate portion 40 is disposed downstream from the second portion 2P, and includes the third cross-section 3C. The third portion 3P is shown disposed adjacent to the outlet 30, wherein the third chamber 65 and the second chamber 64 are still shown in a side-by-side configuration as separated by the second portion 74 of the partition 70. At the third portion 3P of the intermediate portion 40, the first chamber 63 and the fourth chamber 66 are shown as separated from one another on opposite sides of the air duct 10 at the outlet 30. In the configuration shown in FIG. 8, the first chamber 63 is positioned in a side-by-side configuration with the second chamber 64 with the first wall 72A of the first portion 72 of the partition 70 disposed therebetween. The second chamber 64 is shown positioned in a side-by-side configuration with the third chamber 65 with the second portion 74 of the partition 70 disposed therebetween. The third chamber 65 is positioned in a side-by-side configuration with the fourth chamber 66 with the second wall 72B of the first portion 72 of the partition 70 disposed therebetween. Thus, the chambers 63, 64, 65 and 66 are serially aligned in a side-by-side configuration with one another. Thus, the various cross-sections 1C, 2C, 3C are different from one another at the various portions 1P, 2P, 3P of the air duct 10. As used herein, the terms “stacked-configuration” and “side-by-side configuration” are meant to indicate different configurations of chambers at different locations within the interior portion 50 of the intermediate portion 40. As such, in a stacked configuration, one chamber shares a wall with another chamber, with one chamber disposed over another. The same chambers, in a side-by-side configuration, share a wall that is different than the shared wall of the chambers in the stacked configuration. Thus, the first and second chambers 63, 64 share the wall defined by the first divider 84 in the stacked configuration. In the side-by-side configuration, the first and second chambers 63, 64 share the wall defined by the first wall 72A of the first portion 72 of the partition 70. Thus, when keeping the air duct 10 stationary, chambers may be in a first configuration at a first location, such as the stacked configuration of chambers 63 and 64 at first portion 1P shown in FIG. 8. While keeping the air duct 10 stationary, chambers may be in a second configuration at a second location, such as the side-by-side configuration of chambers 63 and 64 at third portion 3P shown in FIG. 8.

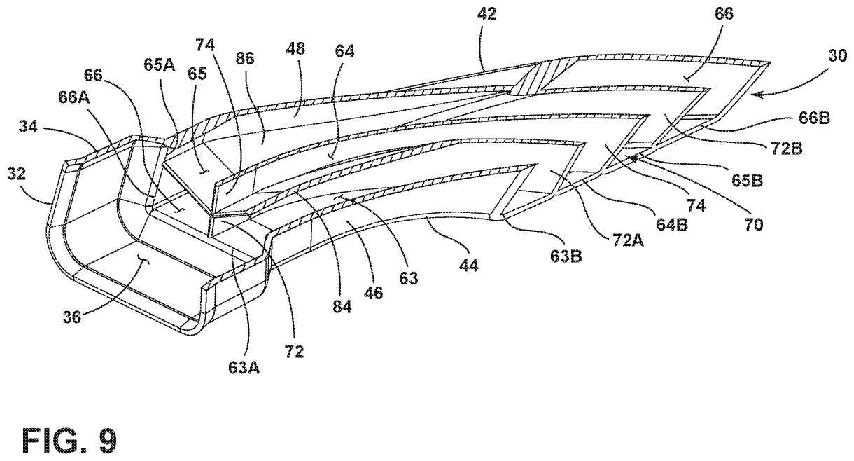

Referring now to FIG. 9, the various halves of the enclosed body portions 63C, 64C, 65C, 66C of the chambers 63, 64, 65 and 66 are shown as interconnecting the supply channel 36 with the outlet 30. As shown in FIG. 9, the first and second walls 72A, 72B of the first portion 72 of the partition 70 increasingly separate from one another in a downstream manner from the inlet 32 to the outlet 30 along the air duct 10.

According to one aspect of the present invention, an air duct includes a supply channel, an outlet, and an intermediate portion interconnecting the supply channel and the outlet. A plurality of chambers is disposed within an interior portion of the intermediate portion. Each chamber of the plurality of chambers includes a first end opening into the supply channel, a second end opening into the outlet and an enclosed body portion interconnecting the first and second ends.

Embodiments of the first aspect of the invention can include any one or a combination of the following features:
the plurality of chambers includes first and second interior channels;
the first and second interior channels are disposed in a side-by-side configuration with a partition separating the first and second interior channels;
each of the first and second interior channels includes a divider dividing the first and second interior channels into first and second chambers;
the first and second chambers of the first interior channel are disposed in a stacked configuration at a first portion of the interior portion adjacent the supply channel;
the first and second chambers of the second interior channel are disposed in a stacked configuration at the first portion of the interior portion adjacent the supply channel;
the first and second chambers of the first interior channel are disposed in a side-by-side configuration at a second portion of the interior portion that is downstream from the first portion and adjacent the outlet; and
the first and second chambers of the second interior channel are disposed in a side-by-side configuration at the second portion of the interior portion.

According to another aspect of the present invention, an air duct includes a supply channel, an outlet and an intermediate portion interconnecting the supply channel and the outlet. The intermediate portion includes opposed first and second sidewalls spaced-apart from one another to at least partially define an interior portion of the intermediate portion. A partition is disposed within the interior portion of the intermediate portion and interconnects the opposed first and second walls to define first and second interior channels. The first and second interior channels each include a first end opening into the supply channel and a second end opening into the outlet.

Embodiments of the second aspect of the invention can include any one or a combination of the following features:
the first interior channel includes a first divider dividing the first interior channel into first and second chambers, and further wherein the second interior channel includes a second divider dividing the second interior channel into third and fourth chambers;
the first and second chambers of the first interior channel are disposed in a first configuration at a first portion of the interior portion adjacent the supply channel, and further wherein the first and second chambers of the first interior channel are disposed in a second configuration that is different from the first configuration at a second portion of the interior portion that is downstream from the first portion of the intermediate portion;
the third and fourth chambers of the second interior channel are disposed in a first configuration at the first portion of the intermediate portion adjacent the supply channel, and further wherein the third and fourth chambers of the first interior channel are disposed in a second configuration that is different than the first configuration of the third and fourth chambers at the second portion of the intermediate portion;
the partition includes a first portion separating the first and fourth chambers at the first portion of the intermediate portion, and further wherein the partition includes a second portion separating the second and third chambers at the first portion of the intermediate portion;
the first portion of the partition separates into first and second walls that separate the first and second chambers and the third and fourth chambers, respectively, at the second portion of the intermediate portion; and
the first and second walls of the first portion of the partition increasingly separate from one another in a downstream manner from the supply channel to the outlet.

According to yet another aspect of the present invention, an air duct includes an inlet and an outlet interconnected to the inlet by a curved intermediate portion. A plurality of chambers is disposed within the curved intermediate portion. Each chamber of the plurality of chambers includes a first end opening into the inlet, a second end opening into the outlet and an enclosed body portion interconnecting the first and second ends. The curved intermediate portion includes a first cross-sectional configuration disposed at a first portion of the curved intermediate portion, and a second cross-sectional configuration that is different from the first cross-sectional configuration disposed at a second portion of the curved intermediate portion. The second portion of the curved intermediate portion is disposed downstream from the first portion of the curved intermediate portion.

Embodiments of the third aspect of the invention can include any one or a combination of the following features:
a partition disposed within an interior portion of the intermediate portion and interconnecting opposed first and second walls of the intermediate portion;
first and second dividers respectively interconnecting the partition to opposed first and second sidewalls of the intermediate portion;
the plurality of chambers includes first and second chambers disposed in a in a stacked configuration at the first portion of the curved intermediate portion, and further wherein the plurality of chambers includes third and fourth chambers disposed in a stacked configuration at the first portion of the curved intermediate portion; and
the first and second chambers are disposed in a side-by-side configuration at the second portion of the curved intermediate portion, and further wherein the third and fourth chambers are disposed in a side-by-side configuration at the second portion of the curved intermediate portion.

It is to be understood that variations and modifications can be made on the aforementioned structure without departing from the concepts of the present invention, and further it is to be understood that such concepts are intended to be covered by the following claims unless these claims by their language expressly state otherwise.

1. An air duct, comprising:
a supply channel;
an outlet;
an intermediate portion interconnecting the supply channel and the outlet; and
a plurality of chambers disposed within an interior portion of the intermediate portion, wherein each chamber of the plurality of chambers includes a first end opening into the supply channel, a second end opening into the outlet and an enclosed body portion interconnecting the first and second ends.

2. The air duct of claim 1, wherein the plurality of chambers includes first and second interior channels.

3. The air duct of claim 2, wherein the first and second interior channels are disposed in a side-by-side configuration with a partition separating the first and second interior channels.

4. The air duct of claim 3, wherein each of the first and second interior channels includes a divider dividing the first and second interior channels into first and second chambers.

5. The air duct of claim 4, wherein the first and second chambers of the first interior channel are disposed in a stacked configuration at a first portion of the interior portion adjacent the supply channel.

6. The air duct of claim 5, wherein the first and second chambers of the second interior channel are disposed in a stacked configuration at the first portion of the interior portion adjacent the supply channel.

7. The air duct of claim 6, wherein the first and second chambers of the first interior channel are disposed in a side-by-side configuration at a second portion of the interior portion that is downstream from the first portion and adjacent the outlet.

8. The air duct of claim 7, wherein the first and second chambers of the second interior channel are disposed in a side-by-side configuration at the second portion of the interior portion.

9. An air duct, comprising:
a supply channel;
an outlet;
an intermediate portion interconnecting the supply channel and the outlet, the intermediate portion having opposed first and second sidewalls spaced-apart from one another to at least partially define an interior portion of the intermediate portion; and
a partition disposed within the interior portion of the intermediate portion and interconnecting the opposed first and second walls to define first and second interior channels, wherein the first and second interior channels each include a first end opening into the supply channel and a second end opening into the outlet.

10. The air duct of claim 9, wherein the first interior channel includes a first divider dividing the first interior channel into first and second chambers, and further wherein the second interior channel includes a second divider dividing the second interior channel into third and fourth chambers.

11. The air duct of claim 10, wherein the first and second chambers of the first interior channel are disposed in a first configuration at a first portion of the interior portion adjacent the supply channel, and further wherein the first and second chambers of the first interior channel are disposed in a second configuration that is different from the first configuration at a second portion of the interior portion that is downstream from the first portion of the intermediate portion.

12. The air duct of claim 11, wherein the third and fourth chambers of the second interior channel are disposed in a first configuration at the first portion of the intermediate portion adjacent the supply channel, and further wherein the third and fourth chambers of the second interior channel are disposed in a second configuration that is different than the first configuration of the third and fourth chambers at the second portion of the intermediate portion.

13. The air duct of claim 12, wherein the partition includes a first portion separating the first and fourth chambers at the first portion of the intermediate portion, and further wherein the partition includes a second portion separating the second and third chambers at the first portion of the intermediate portion.

14. The air duct of claim 13, wherein the first portion of the partition separates into first and second walls that separate the first and second chambers and the third and fourth chambers, respectively, at the second portion of the intermediate portion.

15. The air duct of claim 14, wherein the first and second walls of the first portion of the partition increasingly separate from one another in a downstream manner from the supply channel to the outlet.

16. An air duct, comprising:
an inlet;
